(19) United States
(12) Patent Application Publication
(10) Pub. No.: US 2026/0274131 A1
(43) Pub. Date: Sep. 17, 2026

(54) SEAT

(71) Applicants: INDORAMA VENTURES MOBILITY OBERNBURG GMBH, Obernburg (DE); BAYERISCHE MOTOREN WERKE AKTIENGESELLSCHAFT, Muenchen (DE)

(72) Inventors: Michael NEIDHÖFER, Mainz (DE); Frank LEYMANN, Elsenfeld (DE); Anna GOLDHOFER, München (DE); Konrad LEHERMANN, München (DE)

(73) Assignees: INDORAMA VENTURES MOBILITY OBERNBURG GMBH, Obernburg (DE); BAYERISCHE MOTOREN WERKE AKTIENGESELLSCHAFT, Muenchen (DE)

(21) Appl. No.: 19/167,507

(22) PCT Filed: Mar. 14, 2024
(86) PCT No.: PCT/EP2024/056840

§ 371 Date: Sep. 22, 2025

(30) Foreign Application Priority Data
Mar. 24, 2023 (DE) 10 2023 107 443.1

(51) Int. Cl. B60N 2/58; B60N 2/70

(52) U.S. Cl. CPC B60N 2/5825; B60N 2/5841; B60N 2/7017

(57) ABSTRACT

A seat including at least one padding. The padding includes a first part of a clamping device as well as a three-dimensional network structure. The three-dimensional network structure consists of randomly bonded meshes of one or more continuous linear structures, which are welded together at crossing points and contain at least one thermoplastic elastomer. The material of the first part of the clamping device fills gaps between the linear structures of the network structure. Furthermore, the application relates to a method for producing said seat.

The application relates to a seat comprising a padding.

In order to make them comfortable, seating furniture has been equipped with padding for centuries, which softens the seat surface, the backrest and/or the armrests and is intended to avoid unpleasant bodily reactions, particularly during prolonged sitting. This is especially the case for seating furniture in all kinds of means of transport, which, depending on the occasion, must enable hours of comfortable sitting. In this context, seats in motor vehicles and airplanes in particular must be mentioned. In motor vehicles, especially cars, it plays a decisive role that getting up during the ride is almost completely impossible, and the seat can therefore only be left if the vehicle is left as well, for example during breaks. In airplanes it is of decisive importance that intercontinental flights in particular may last several hours or even overnight, so that passengers, especially for sleeping, remain in their seats for a very long time.

However, the requirement profile for seats in means of transport is not limited to comfort. In fact, particularly in airplanes, extremely restrictive requirements regarding weight must be observed.

In addition, especially in recent times, there is the demand for recyclability. This is particularly not the case for seats whose padding is based on foams, such as polyurethane foams (PU foams). Moreover, foam-based padding does not consist of monolithic foam blocks. The seats must contain fastening means that make it possible to attach cover materials to the padding. These usually involve wires or clips, which are inserted into the corresponding moulds before foaming and are then embedded in the foam during the formation thereof.

In addition to poor recyclability, PU-foam-based seats have the major disadvantage that their production is extremely time-consuming. PU foam is produced in the mould by mixing a polyol component and an isocyanate component with a foaming agent. However, isocyanates are extremely toxic, and it must therefore be ensured for safe handling of the padding that the reagents have completely reacted when the padding is removed from the mould. For this purpose, long curing times are required after adding the reagents, which make the manufacture of the padding time-consuming.

These problems are partly solved by replacing PU foams with three-dimensional fiber networks. However, padding made of such three-dimensional fiber networks also still contains clips and/or wires made of foreign material, i.e. materials other than the three-dimensional fiber material, which prevents recycling of the padding and thus also of the seat. Moreover, in some cases, the padding also contains binders, in particular elastomeric and/or thermosetting binders, which serve, for example, to hold fastening means such as clips and/or wires in position. Binders further complicate or completely prevent recycling of the padding.

It is therefore the object of the invention to provide a comfortable, lightweight and readily recyclable seat suitable for all types of means of transport.

This object is achieved by a seat comprising at least one padding, the padding comprising a first part of a clamping device as well as a three-dimensional network structure consisting of randomly bonded meshes of one or more continuous linear structures, said continuous linear structures being welded together at crossing points, said continuous linear structures comprising at least one thermoplastic elastomer, characterized in that the material of the first part of the clamping device fills gaps between linear structures of the network structure.

A seat in the sense of the present application is a piece of furniture essentially intended for people to sit on. Such furniture is generally known under various terms, including to a skilled person. Accordingly, a seat within the meaning of the present application is understood to encompass all types of seating furniture, in particular those known as stools, benches, chairs, armchairs, thrones, sofas, canapés, benches, couches, or recamiers. Among these types of seating furniture are usually items of furniture for living or working spaces; however, seats explicitly also include those intended for accommodating passengers in private or public means of transport, such as seats in cars, buses or other road vehicles, seats in rail vehicles, seats in aircraft or on ships, particularly on ferries.

Seats in means of transport, but also many seats serving as items of furniture, usually comprise padding.

Padding within the meaning of the present application refers to resilient, elastic bodies connected to a seat and intended to increase seating comfort by cushioning overly hard force impacts on the buttocks, the back, the thighs or other body parts of the seated person. In particular, prolonged sitting, for example in means of transport, is significantly facilitated by the padding of the seats intended for this purpose.

A clamping device within the meaning of the present application is a fastening means consisting of at least two parts. One part of the clamping device is designed to exert force on another part in such a way that the first and second parts enter into a detachable mechanical connection, which may be a frictional connection, a positive connection, or a combination thereof.

In one embodiment, one part of the clamping device may be a clip. The clip may, for example, consist of two hooks located close to each other and connected, for instance, to a platform, and designed so that they exhibit a certain degree of flexibility relative to each other.

The other part may then represent a pin, which can be gripped or enclosed by the clip. The pin may, for example, be a pin with a surface texture such as a groove. In one embodiment, the pin can be inserted between the hooks of the clip, the hooks of the clip moving apart during insertion and returning to their original position when they engage into the surface texture of the pin. Thus, the pin is gripped by the clip and is detachably connected to it, wherein releasing the connection requires more force than closing the connection. The closing of the connection is known to the skilled person in the described form as “snapping in”.

In one embodiment, the first part of the clamping device is capable of exerting a force of not less than 70 N on a second part of the clamping device in contact with it. Accordingly, the force required to separate the two parts of the clamping device is not less than 70 N.

The first part of the clamping device, which is located on the padding within the meaning of the present application, may be any part of a clamping device.

Accordingly, in one embodiment of the present application, the first part of the clamping device may be a clip, and in another embodiment, the first part of the clamping device may be a pin.

The padding according to the present application comprises a three-dimensional network structure containing randomly bonded meshes of one or more continuous linear structures. The continuous linear structures are welded together at crossing points.

Continuous linear structures within the meaning of the present application may be, for example, threads, yarns, fibers or filaments. A filament is understood to be a single fiber whose length is practically infinite compared to its thickness. Individual filaments may have a length of one meter or more at a thickness of a fraction of a millimeter. The length of a filament may even amount to one kilometer or more.

Threads or yarns are structures consisting of more than one fiber or more than one filament, the fibers or filaments being connected together by twisting, entangling, gluing, or welding so that they can be handled collectively, i.e. produced, wound, transported, and processed as a fiber bundle. Threads and yarns may contain both filaments and shorter fibers, i.e. fibers with a length of less than one meter, which are then formed into a thread or a yarn, for example, by twisting.

The network structure of the padding is formed by randomly bonded meshes of the one or more continuous linear structures, the one or more continuous linear structures being laid into meshes so that they form a three-dimensional structure, which is held in shape by punctual welds at crossing points. In one embodiment, this is a self-supporting structure that can be compressed by the action of an external force and develops internal stresses when compressed. These internal stresses ensure that the three-dimensional network structure springs back to its original shape once the force ceases.

In one embodiment, the three-dimensional network structure forms an elastic, resilient fiber mat.

It is important to emphasize that in a three-dimensional network structure according to the present application, there is empty space or air, or another gas, between the continuous linear structures, as already implied by the designation “meshes” for the intermediate spaces.

In one embodiment, the meshes of the three-dimensional network structure—apart from impurities—are free from solid substances such as foams or binders. Furthermore, it is important to emphasize that the term “elastic”, attributed to the three-dimensional network structure, by no means necessarily requires that the three-dimensional network structure contains classical elastomers in any way.

Classical elastomers, which consist of weakly cross-linked macromolecules, are to be distinguished from thermoplastic elastomers.

The continuous linear structure according to the present application comprises at least one thermoplastic elastomer. Thermoplastic elastomers are high-molecular compounds (“polymers”) which exhibit elastic properties at a temperature of 298 K but, at higher temperatures, are thermally deformable like thermoplastics. In contrast to classical elastomers, such as rubber, which are composed of slightly cross-linked macromolecules, thermoplastic elastomers consist of uncross-linked, chain-like macromolecules and, unlike classical elastomers, can be deformed and melted by the action of heat without chemical decomposition. This makes it possible to recycle thermoplastic elastomers like classical thermoplastics, which is not possible with classical elastomers since they are not fusible or thermally formable.

Typical thermoplastic elastomers belong to the known families of thermoplastic polymers, such as polyamides or polyesters. In general, polyamides are polymers formed by the creation of amide groups between amino groups and carboxylic acid groups of their monomers. The simplest polyamides are produced either by polymerization of a dicarboxylic acid and a diamine, such as adipic acid and hexamethylenediamine, which together form polyamide-6,6, or by polymerization of an amino carboxylic acid or a lactam, such as ε-caprolactam, which polymerizes into polyamide-6. However, polyamides composed of a dicarboxylic acid and a diamine, or of a lactam or an amino carboxylic acid, do not exhibit elastomeric properties. For this, the involvement of additional monomers is required, which are incorporated into the macromolecules during polymer formation and prevent the creation of excessively large, regular, and therefore crystalline regions of aggregated polymers. Instead, thermoplastic elastomers have smaller crystalline regions, in which adjacent macromolecules are cross-linked by non-chemical interactions in such a way that the cross-linking can be dissolved by the action of heat and re-established upon cooling. The formation of such weak cross-links is possible with copolymers whose chains contain more different monomers than are absolutely necessary for chain formation. In the case of the polyamides mentioned above, for example, a thermoplastic elastomer may be formed from a dicarboxylic acid and two or more different diamines, or from two or more different dicarboxylic acids and one diamine. It is also possible to form it from two or more different amino carboxylic acids or two or more different lactams.

The simplest polyesters are produced by polymerization of a dicarboxylic acid with a dialcohol. In this way, for example, polyethylene terephthalate (PET) is formed from ethylene glycol and terephthalic acid. Polymerization of a hydroxycarboxylic acid or a lactone is also possible. In this way, for example, polylactide (PLA) is formed from lactic acid or polycaprolactone from caprolactone. Polyesters composed only of a dicarboxylic acid and a dialcohol or a hydroxycarboxylic acid or lactone do not exhibit elastomeric properties. In order to achieve elastomeric properties, the number of monomers must also be increased here, so that two or more dicarboxylic acids and/or two or more dialcohols are used. The use of two or more hydroxycarboxylic acids or two or more lactones is also possible.

Thermoplastic elastomers based on polyesters are typically divided into two classes, polyester-ester block copolymers and polyester-ether block copolymers. Both groups have in common that they possess “hard” and “soft” chain segments.

In thermoplastic elastomers of the group of polyester-ester block copolymers, both the hard and the soft chain segments are formed from polyester units.

The dicarboxylic acids used for both the hard and the soft chain segments may include aromatic carboxylic acids such as terephthalic acid, isophthalic acid, naphthalene-2,6-dicarboxylic acid, naphthalene-2,7-dicarboxylic acid, and diphenyl-4,4′-dicarboxylic acid, as well as alicyclic carboxylic acids such as 1,4-cyclohexyl dicarboxylic acid, and aliphatic dicarboxylic acids such as succinic acid, adipic acid, sebacic acid, and fatty acid dimers (“dimer acids”). Derivatives of the mentioned carboxylic acids, such as carboxylic acid anhydrides or halides, may also be used.

For the diol component of the “hard” chain segments, for example, aliphatic diols such as 1,4-butanediol, ethylene glycol, trimethylene glycol, pentamethylene glycol, hexamethylene glycol, or alicyclic diols such as 1,1-cyclohexane dimethanol and 1,4-cyclohexane dimethanol may be used. Ester-forming derivatives of these diols, such as the corresponding chloro-, bromo- or iodoalkanes, may likewise be employed.

Furthermore, so-called polyester diols may be used. These are oligomers or polymers, like polyesters, built from dicarboxylic acids and diols, from hydroxycarboxylic acids or lactones, but in which both chain ends contain hydroxyl groups, thereby enabling them to integrate as diol units in polyester chains.

Polyester diols may include polylactones such as polycaprolactone, which are modified by reaction with a diol or a precursor thereof, such as a haloalkanol, so that both chain ends have hydroxyl groups. Polyester diols typically have an average molar mass of 300 to 5000 g/mol. Polyester diols are usually based on aliphatic polyesters.

Embodiments of polyester-ester block copolymers are, for example, triblock copolymers that contain terephthalic acid and/or naphthalene-2,6-dicarboxylic acid as the dicarboxylic acid, 1,4-butanediol as the diol component, and polylactone as the polyester diol.

Polyester-ether copolymers may be based on the same dicarboxylic acids and diols as polyester-ester copolymers. In addition, the base may also be a polymerized hydroxycarboxylic acid or a polymerized lactone. However, instead of a polyester diol component, polyester-ether copolymers contain a polyether diol component as the “soft” chain segment. The polyether diol component may be, for example, polyalkylene diols such as polyethylene glycol, polypropylene glycol, polytetramethylene glycol, as well as ethylene oxide-propylene oxide copolymers. The average molar mass of the polyether diol component may range from 300 to 5000 g/mol.

In one embodiment, the three-dimensional network structure consists of a thermoplastic elastomer.

In one embodiment, the first part of the clamping device contains a polymer of the same polymer family as the three-dimensional network structure. Thus, if the network structure contains a thermoplastic elastomer based on polyester, such as a polyester-ester copolymer or a polyester-ether copolymer, the first part of the clamping device likewise contains a polyester such as polyethylene terephthalate, polytrimethylene terephthalate or polybutylene terephthalate. If both the three-dimensional network structure and the first part of the clamping device contain polymers of the same polymer family, this improves the recyclability of the padding, since the clamping devices do not have to be separated from the padding for recycling. Moreover, fastening of the first part of the clamping device to the padding can be improved, because in addition to a positive connection, a material-bonded connection is also established.

Recycling of polymers of the same polymer family is possible, for example, by depolymerization processes, in which the polymers are split into their monomers and the monomer mixture thus obtained is, for example, separated by distillation and reused. Since the recovered monomers can be purified very effectively in depolymerization processes, it is particularly easy to produce polymers of very high quality from them. However, depolymerization processes are comparatively complex in terms of process technology and economics.

In one embodiment, the three-dimensional network structure and the first part of the clamping device consist of the same polymer and can therefore be recycled particularly easily together. Joint recycling can then be carried out without depolymerization techniques and only by jointly melting the padding with the first part of the clamping device.

The first part of the clamping device according to the present application is connected to the padding in such a way that the material of the first part of the clamping device fills gaps between linear structures of the three-dimensional network structure. Filling gaps between the linear structures can result in the first part of the clamping device having irregularly shaped edges.

As a result, the first part of the clamping device is inseparably connected to the network structure of the padding. “Inseparably” in the sense of the present application means that it is not possible to detach the connection without cutting through material and thus at least partially destroying the network structure. The inseparable connection may be achieved solely by positive fit or by a combination of positive fit and material bonding. The occurrence of a material bond depends on the choice of material both of the network structure and of the first part of the clamping device.

In one embodiment, the padding comprises channels in which the first parts of the clamping device are located. These channels, also known to the skilled person as “filing channels”, are usually notches in the padding that are so narrow that their deepest point is only visible when the padding is pulled apart under mechanical load.

The channels serve the function of concealing the first part of the clamping device in such a way that the clamping device, which may be harder than the padding, cannot be felt by the person sitting on the padding and thus does not impair seating comfort. To fulfill this function, the channels must have sufficient depth, with the depth of the channels also being adapted to the deformability of the network structure of the padding. The depth of the channels may also be chosen such that not only the first part but also a second part of the clamping device, which is connected to the first part of the clamping device, can no longer be felt by a person sitting on the padding. In this way, the channels serve to fasten, for example, cover material to the padding.

In one embodiment, the channels can be produced by a thermoforming process. The thermoforming process may consist of providing an otherwise manufactured network structure solely with channels. However, the thermoforming process may also serve to reshape an already manufactured network structure as a whole and simultaneously provide it with channels.

The network structure may, for example, be present in the form of cuboids, blocks, T-profiles, I-beams, or in other forms. By thermoforming, these network structures can be brought into another shape as required for use as padding. This may involve rounding corners and edges as well as shaping, for example, a seat depression adapted to the shape of the buttocks.

Thermoforming can be carried out using appropriate moulds. Typical moulds consist of two or more parts which are joined together during the forming process in such a way that they enclose a cavity corresponding to the shape into which the network structure is to be brought. The outer shape, such as corners, edges or depressions, is specified by the outer walls of the mould. The channels are created by thin plates on the inside of the mould, known to the skilled person as “blades”. For thermoforming, a network structure is provided and heated to a temperature at which the network structure becomes plastically deformable but not yet liquefied. The mould is then closed around the heated network structure and the network structure cooled in the mould to a temperature at which it is no longer deformable. The mould is then opened and the thermoformed network structure removed. To facilitate removal from the mould, it may be necessary to treat the mould with suitable release agents such as silicone oils before thermoforming.

Alternatively, it is also possible to provide the inner surfaces of the mould with a non-stick coating. Suitable coatings, which must withstand the temperatures of the thermoforming process, are known to the skilled person.

In one embodiment, the seat comprises a cover material. The cover material contains a second part of the clamping device and is connected to the padding by the contact of the first part of the clamping device with the second part of the clamping device.

The cover material has the function of covering the open surface of the padding and thus protecting it, for example, against the penetration of dust, dirt and vermin. In addition, it may cover the surface of the padding in an optically and/or haptically appealing manner and is furthermore open to design considerations. By choosing the cover material, the seat according to the invention can be designed accordingly and, for example in the case of seats in aircraft or rail vehicles, adapted to the corporate identity of the operator.

The cover material may consist of all materials that meet the requirements for appearance and feel. Textile materials such as velour, plush or simple fabrics are conceivable, which may consist of natural fibers such as cotton, as well as of man-made fibers such as viscose or lyocell, or of synthetic fibers such as polyester, polyamide or polyacrylonitrile. In addition, leather and artificial leather are also conceivable as cover materials. Artificial leather is generally understood to mean fabrics coated with polymers such as polyvinyl chloride or polyurethane, or polymer films such as polyurethane films.

If the padding comprises channels and the first part of the clamping device is located in the channels, the cover material is pushed into the channels for fastening to the padding, and the second part of the clamping device is connected to the first part of the clamping device. As a result, the cover material has a fold whose depth corresponds to the depth of the channel. To prevent dirt, dust and vermin from penetrating and accumulating in this fold, the fold may be closed by sewing on a welt or a piping. This also contributes to making the seat visually more homogeneous.

In one embodiment, the connection between the first part of the clamping device and the second part of the clamping device is a detachable connection.

Detachable connections may be released, for example, by a certain amount of force or by a particular type of movement, and the two parts of the clamping device can be separated from each other without destruction. The clamping devices should be designed in such a way that separating the first part and the second part is technically as simple as possible and feasible without special equipment, for example if cover materials need to be replaced and/or removed for the purpose of recycling.

In one embodiment, the pull-off force required to detach the cover material from the padding is not less than 70 N.

In one embodiment, the cover material and the second part of the clamping device contain a polymer from the same polymer family as the three-dimensional network structure. Thus, if the three-dimensional network structure contains a thermoplastic elastomer based on polyester, such as a polyester-ether copolymer or a polyester-ester copolymer, the cover material likewise contains a polymer from the polyester family, such as polyethylene terephthalate, polybutylene terephthalate or polytrimethylene terephthalate.

In one embodiment, the cover material and the second part of the clamping device consist of the same polymer as the three-dimensional network structure and the first part of the clamping device. In this way, the seat according to the application can be recycled very easily as a whole.

In one embodiment, the linear structures forming the network structure are wholly or partly hollow. Hollow linear structures have the form of tubes or hoses and are characterized by a particularly low specific weight, which is of particular interest for use in seats in means of transport such as cars, rail vehicles or aircraft. In addition, hollow linear structures provide the possibility of filling the same volume with less material.

Hollow linear structures may be combined with solid, i.e. non-hollow, linear structures in all ways known to the skilled person when constructing the network structure. It is possible, for example, that hollow and solid linear structures form different, separate or intergrading layers within the network structure. In one embodiment, for example, the inner region of the network structure contains hollow linear structures and is covered by a thin layer of solid linear structures, which forms the outer finish and, for example, establishes contact with a cover material. Moreover, the layer of solid linear structures may have a greater density than the underlying regions and thus increase the seating comfort of the padding and thus of the seat.

In one embodiment, the linear structures forming the three-dimensional network structure have not less than 200 bonding points per gram of the three-dimensional network structure.

The bonding points of the linear structures laid in meshes ensure the cohesion and the three-dimensional construction of the network structure. Their number per mass unit of the network structure is of decisive importance for its compressibility and its ability to spring back to its original shape after compression. Thus, the number of bonding points is of importance for the perceived “hardness” or “softness” of the padding and of the entire seat, and therefore for the seating comfort of the seat according to the present application. In one embodiment, the number of bonding points is not less than 500 per gram of the network structure.

In one embodiment, the fineness of the linear structures forming the three-dimensional network structure is not less than 100 dtex and not more than 60,000 dtex. One dtex means that 10 kilometers of the corresponding linear structure have a mass of one gram. At a fineness of 100 dtex, the mass of 10 kilometers of the linear structure is therefore 100 grams.

In one embodiment, the fineness of the linear structure is not less than 200 dtex and not more than 10,000 dtex.

The fineness of the linear structure plays a role in the haptic impression of the padding. The finer the linear structures are formed, the more the haptics resemble those of a homogeneous structure. Linear structures with lower fineness lead to a coarser appearance of the network structure, which feels less pleasant and may put greater mechanical stress on a cover material.

In one embodiment, the diameter of the linear structure is not less than 0.1 mm and not more than 0.65 mm. The diameter of the linear structure influences the haptics of the padding in a manner similar to the fineness, but it is important to emphasize that the diameter and the fineness of the linear structure are not directly correlated. On the one hand, this is because, in addition to the diameter of the linear structure, the specific weight of the material of the linear structure also plays a role in determining fineness; on the other hand, because the linear structure does not necessarily have to be homogeneous over its entire diameter but can, for example, be hollow.

In one embodiment, the network structure has a raw density of not less than 5 kg/cm³ and not more than 200kg/cm³. The raw density is the density of the network structure as produced and before being subjected to any forming processes such as thermoforming. The lower the raw density of the network structure, the lower the weight of the padding containing it and thus of the seat containing it.

In one embodiment, the seat as a whole according to the present application, or the padding contained in the seat as a whole, can be recycled. In principle, several processes are available for the recycling of polymer waste, but these only deliver a usable product if, in these processes, only products made from the same polymer or at least from the same polymer family are recycled simultaneously. For the polymer families of polyesters and polyamides in particular, depolymerization processes are used, for example, in which the polymer chains are wholly or partially broken down into their monomers, the monomers are separated and purified, and then repolymerized, yielding a product that is practically indistinguishable from virgin material. However, this involves comparatively high economic and technical effort.

Processes in which a polymer is melted, optionally post-treated, and then reshaped into new products are considerably easier to carry out. However, such melting processes can only be realized with goods consisting entirely of the same or at least extremely similar polymers.

The application also relates to a method for fastening a first clamping device to a padding, the padding comprising a three-dimensional network structure consisting of randomly bonded meshes of one or more continuous linear structures, said continuous linear structures being welded together at crossing points, said continuous linear structures comprising at least one thermoplastic elastomer, characterized in that the first clamping device is attached to the network structure in an injection moulding process using a two-part mould, wherein the parts of the mould clamp part of the network structure. In one embodiment, this is done in such a way that the mould is leaky at the interface of the two parts during the moulding process.

Injection moulding processes in the sense of the present application are all processes in which a melt, such as a polymer melt, is injected under pressure into a mould consisting of at least two parts, fills this mould, and is cooled and thus solidified therein. The mould is normally designed so that the at least two parts are fitted together in a leak-proof manner, so that the polymer melt cannot escape from the mould through gaps or leaks, in order to save material and achieve consistent, reproducible shaping.

By separating the mould parts, the moulded object can then be removed from the mould. Injection moulding is usually the method of choice when small to medium-sized moulded parts with high and consistent precision are to be produced from thermoplastic plastics.

The first part of the clamping device in the sense of the present application is a small moulded part made of a thermoplastic plastic. In order to ensure a good connection with the second part of the clamping device, consistent precision of shaping is required, so that the production of the first part of the clamping device by injection moulding is an obvious option. It has now been found, surprisingly, that the first part of the clamping device can be connected to the three-dimensional network structure in a particularly efficient way if the two parts of an injection mould for the first part of the clamping device enclose part of the three-dimensional network structure, so that part of the linear structures forming the network structure are located between the parts of the injection mould. The linear structures are thus clamped between the mould parts when the injection mould is closed.

The clamped linear structures cause the mould parts not to be joined together as tightly as is usual in injection moulding. Instead, a gap forms between the parts, through which the polymer melt can initially escape from the mould at the beginning of the injection process. When the injection process is started, the polymer melt fills the mould, flowing around the linear structures enclosed by the parts of the mould and out of the mould through the incompletely joined parts of the injection mould. As a result, the first part of the clamping device is anchored in the three-dimensional network structure. The anchoring is not limited to a surface corresponding to the base area of the first part of the clamping device but, due to the outflow of polymer melt from the injection mould, the surface on which the first part of the clamping device is anchored in the three-dimensional network structure is particularly large. In this way, a good and stable positive connection between the first part of the clamping device and the three-dimensional network structure is achieved.

In one embodiment, for the manufacture of the first part of the clamping device, a polymer from the polymer family is used which is also contained in the three-dimensional network structure or of which the three-dimensional network structure consists of. Thus, if the three-dimensional network structure contains a thermoplastic elastomer from the family of polyester-ester copolymers or polyester-ether copolymers, the first part of the clamping device in this embodiment contains a polymer from the polyester family, such as polyethylene terephthalate, polytrimethylene terephthalate or polybutylene terephthalate.

In one embodiment, the same polymer is used to manufacture the first part of the clamping device as is also contained in the three-dimensional network structure or of which the three-dimensional network structure consists of. As a result, the padding together with the first part of the clamping device can be easily recycled after removal of the cover material.

It has surprisingly been found that the use of the same polymer in the three-dimensional network structure and in the first part of the clamping device brings another advantage for the method according to the present application. Polymer melts typically used for injection moulding have low viscosities to ensure good and rapid filling of the mould. By contrast, polymer melts required to produce continuous structures, as for the three-dimensional network structure according to the present application, have significantly higher viscosity. However, this has the advantage in the process according to the application that the outflow of polymer melt from the injection mould during the injection process is reduced and can be better controlled than with a low-viscosity polymer melt as usually used for injection moulding. The solution viscosity of a suitable polymer is 2.8-3.2; in one embodiment the solution viscosity is 3.0. The solution viscosity is determined according to DIN EN ISO 1628-5:2015-05, Polymer solution concentration 0.01 g/cm³, solvent phenol/1,1,2,2-tetrachloroethane (60:40 by mass), dissolution 15 min at 135° C., Ubbelohde viscometer capillary II, measurement temperature 25° C., results calculated according to m-cresol (factor 0.914).

The present application also relates to the use of a thermoplastic elastomer with a solution viscosity of 2.8-3.2 in an injection moulding process.

### FIGURES

FIG. 1 shows a three-dimensional network structure to which the first part of a clamping device 2 is attached in such a way that the material of the first part of the clamping device 2 fills gaps between linear structures of the three-dimensional network structure 3, 2a. Due to its production in the injection moulding process, the first part of the clamping device has a sprue 3. The second part of a clamping device 4 engages into the first part of the clamping device 2. This engagement generates a holding force that holds the second part of the clamping device in the first part of the clamping device. The holding force is indicated by the arrow.

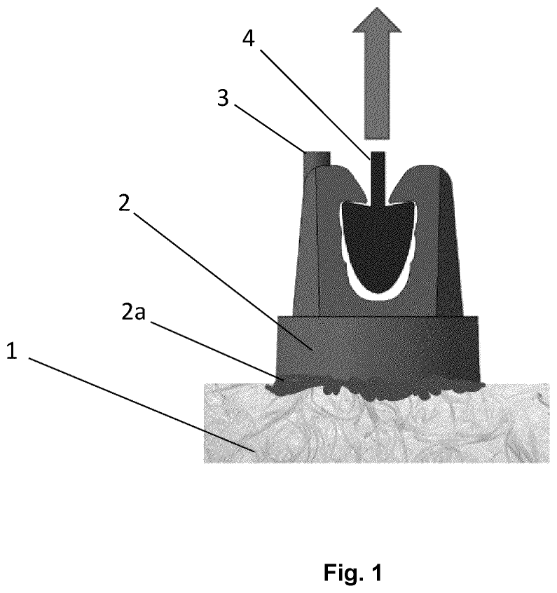

FIG. 2 shows a photograph of a three-dimensional network structure 1 on which the first part of a clamping device 2 is located, which due to its production in the injection moulding process has a typical sprue 3

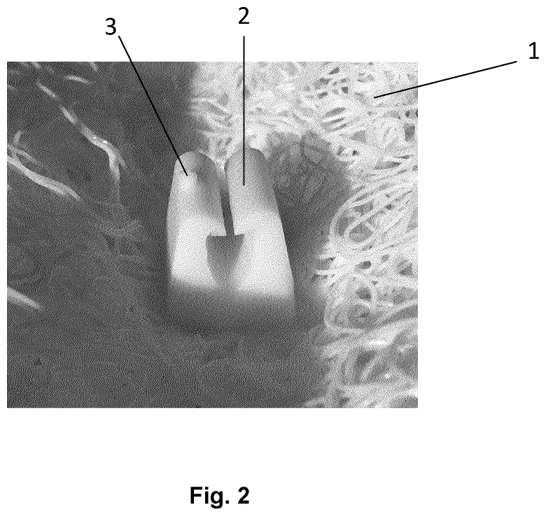

1. Seat comprising
at least one padding, the padding comprising
a first part of a clamping device, and
a three-dimensional network structure consisting of randomly bonded meshes of one or more continuous linear structures, said continuous linear structures being welded together at crossing points, the continuous linear structures comprising at least one thermoplastic elastomer,
wherein
the material of the first part of the clamping device fills gaps between linear structures of the network structure.

2. Seat according to claim 1, wherein the padding comprises channels in which the first parts of the clamping device are located.

3. Seat according to claim 1, additionally comprising a cover material, the cover material comprising a second part of the clamping device, wherein the cover material is connected to the padding by contact of the first part of the clamping device with the second part of the clamping device.

4. Seat according to claim 1, wherein the linear structures forming the padding are wholly or partly hollow.

5. Seat according to claim 1, wherein the three-dimensional network structure has not less than 200 bonding points.

6. Seat according to claim 1, wherein the continuous linear structure has a fineness of not less than 100 dtex and not more than 60,000 dtex.

7. Seat according to claim 1, wherein the continuous linear structure has a diameter of not less than 0.1 mm and not more than 0.65 mm.

8. Seat according to claim 1, wherein the network structure has a raw density of 5 to 200kg/cm³.

9. Seat according to claim 1, wherein the thermoplastic elastomer is a thermoplastic elastomer based on polyester.

10. Seat according to claim 1, wherein the first part of the first clamping connection contains a thermoplastic elastomer of the same polymer family.

11. Seat according to claim 1, wherein the cover material and the second part of the clamping device contain a polymer of the same polymer family as the network structure.

12. Seat according to claim 1, wherein the seat as a whole or the padding as a whole can be recycled.

13. Method for fastening a first part of a clamping device to a padding, the padding comprising
a three-dimensional network structure consisting of randomly bonded meshes of one or more continuous linear structures, said continuous linear structures being welded together at crossing points, the continuous linear structures comprising at least one thermoplastic elastomer,
wherein the first part of the clamping device is attached to the network structure in an injection moulding process using a two-part mould, wherein the parts of the mould clamp part of the network structure.

14. Method according to claim 13, wherein for the injection moulding process the thermoplastic elastomer used is the same as that contained in the network structure and wherein the thermoplastic elastomer has a solution viscosity of 2.8-3.2, according to DIN EN ISO 1628-5:2015-05.

15. An injection moulding process comprising injection moulding a melt of a thermoplastic elastomer with a solution viscosity of 2.8-3.2, according to DIN EN ISO 1628-5:2015-05.
